(19) United States
(12) Patent Application Publication
(10) Pub. No.: US 2009/0270123 A1
(43) Pub. Date: Oct. 29, 2009

(54) Method for configuring a Radio Receiver, Radio Receiver, and a First Transmitter

(76) Inventors: Jorg Heuer, Oberhaching (DE); Uwe Rauschenbach, Poing (DE)

Correspondence Address: LERNER GREENBERG STEMER LLP, P O BOX 2480, HOLLYWOOD, FL, 33022-2480, US

(21) Appl. No.: 12/298,494

(22) PCT Filed: Apr. 24, 2007
(86) PCT No.: PCT/EP07/54010

§ 371 Date: Apr. 17, 2009

(30) Foreign Application Priority Data
Apr. 24, 2006 (DE) 10 2006 019 403.9

(51) Int. Cl. H04M 1/00; H04B 1/06

(52) U.S. Cl. 455/552.1; 455/230; 375/316

(57) ABSTRACT

The invention relates to a method for configuring a radio receiver, in which at least one parameter is received by a first receiving means via a first connection of a first network, at least one configuration parameter is generated by evaluating the parameter, and a second connection to a second network is established by a second receiving means of the radio receiver based on the configuration parameter. The invention further relates to said radio receiver as well as a first transmitter of the first network.

### CLAIM FOR PRIORITY

This invention is a national stage application of PCT/EP2007/054010, filed Apr. 24, 2007, which claims priority to DE 10 2006 019 403.9, filed Apr. 24, 2006, the contents of which are hereby incorporated by reference.

### TECHNICAL FIELD OF THE INVENTION

The invention relates to a method for configuring a radio receiver, to a radio receiver, and to a first transmitter.

### BACKGROUND OF THE INVENTION

When setting configuration parameters for radio receivers in receiving devices, for example in stationary television sets, the stations to be received are set manually or automatically by a user, for example, by starting a station search in the receiving device. In this case, configuration parameters of the stations which can be received, for example the bandwidth and channel, are stored in the terminal, with the result that the user can jump back and forth between the stations by reading the configuration parameters. Such an operation of setting the stations is time-consuming and so an automatic search requires several minutes. This is not problematic as a rule since the setting operation has to be carried out only when the radio receiver is used for the first time.

However, if mobile radio receivers are used, the procedures mentioned are not practical since the mobile radio receiver continuously changes its location and an operation of setting the configuration parameters for stations which can be received thus has to be carried out again and again.

### SUMMARY OF THE INVENTION

The invention is specifies a method, a receiving device and a first network unit which eradicate the known disadvantages in a simple and cost-effective manner.

The invention relates to a method for configuring a radio receiver, in which at least one parameter is received by the radio receiver via a first connection of a first network, at least one configuration parameter is generated by evaluating the parameter, and a second connection to a second network is established by the radio receiver on the basis of the configuration parameter.

This method is advantageous since a service provider can individually dynamically adapt its receivable contents, for example pieces of music, an electronic newspaper or films, to a terminal comprising the radio receiver and/or to the needs of a user operating the terminal. Furthermore, the radio receiver can be configured automatically, with the result that the user does not have to carry out a manual setting operation, for example the operation of looking for a particular film in a new cell of the second network following a handover.

Within the scope of this invention, the configuration parameter should be understood as meaning a parameter which is needed in the radio receiver to correctly receive data, for example an image sequence or a piece of music, broadcast by a second transmitter of the second network. The configuration parameter(s) is/are selected according to the transmission standard supported in the second network.

The radio receiver may be part of a mobile radio, for example according to the GSM standard, or a portable multimedia terminal, for example a mobile TV or a music receiving device. In addition, the radio receiver may form part of a network element, the radio receiver forwarding radio data, for example a film or a piece of music, received via the second network to another network element.

If the parameter is requested by the radio receiver using a request message, the radio receiver may independently determine the point in time at which it receives the parameter. If at least one current configuration parameter of the radio receiver is additionally added to the request message, the first network can evaluate the request message in a targeted manner and can adapt the parameter according to the current configuration value. Within the scope of this invention, the current configuration value is generally understood as meaning a value of the current configuration of the first and/or second network, for example a cell ID of the first network in which the radio receiver is situated, an IPDC service ID (IPDC—IP Datacast) and/or a reception frequency of the second network. If the first network is additionally or alternatively provided with the request message when a reception quality of the second network is undershot, the radio receiver can request new parameters and can thus generate new configuration parameters which make it possible to improve the reception quality.

The parameter is preferably delivered to the radio receiver without a request from the radio receiver. The radio receiver can therefore generate new configuration parameters only by receiving the parameters. This procedure makes it possible, on the one hand, for the radio receiver to save energy since it does not send a message. On the other hand, it is ensured that the radio receiver is currently provided with changes which affect the second network. Furthermore, a first transmitter of the first network can simultaneously send the parameter to a plurality of radio receivers, with the result that this procedure saves bandwidth.

If the configuration parameter is generated by evaluating the parameter on the basis of a database in the radio receiver, the radio receiver can individually create the configuration parameter applicable to it. It is possible to reduce a volume of data which relates to the parameters and is to be transmitted via the first connection by using the database since, for example, only an index has to be transmitted.

A group of associated configuration parameters can be read from the database with the aid of this index.

An indication of the position of the radio receiver is preferably determined using either at least one reception parameter of the first network or a positioning device, and at least one of the configuration parameters is generated by evaluating either the indication of position on the basis of the database or by evaluating the parameter which is requisitioned using a request message which comprises the indication of position. Within the scope of this invention, the indication of position is understood as meaning an indication of an item of location information which can be used to locate the radio receiver. This indication of position is, for example, an indication of longitude and latitude in degrees, a cell ID of the first and/or second network or an area in which there is a particular area code for a fixed network or an area with particular reception conditions for the second network.

The first network is preferably used to represent a unidirectional or bidirectional network, in particular a bidirectional network according to a UMTS, GSM, WLAN or WIMAX standard. In a further refinement, the second network is used to represent a radio network, in particular according to a DVB-H, DVB-T, DAB or DMB standard. If the second network is a DVB-T (DVB-T—Digital Video Broadcast Terrestrial), at least one of the configuration parameters and/or parameters may comprise one of the following items of information:
reception frequency
DVB network ID
DVB original network ID
DVB transport stream ID
DVB service ID.

If the second network is operated according to DVB-H (DVB-H -Digital Video Broadcast Handheld), at least one of the configuration parameters and/or parameters may comprise one of the following items of information:
reception frequency
DVB network ID
DVB original network ID
DVB transport stream ID
IP platform ID for selecting an IP data stream
ID of the IPDC electronic service guide provider
IPDC service ID for selecting a service.

The parameter is preferably generated on the basis of a position of the radio receiver inside the first network. This makes it possible to locally locate the radio receiver in a simple manner.

The invention also relates to a radio receiver comprising the following means:
first receiving means for receiving at least one parameter via a first connection of a first network;
evaluation means for generating at least one configuration parameter by evaluating the at least one parameter;
second receiving means for establishing a second connection to a second network on the basis of the at least one configuration parameter.

The method can thus be carried out in the radio receiver. In addition, the radio receiver may comprise further means which allow at least one of the extensions to be implemented.

Finally, the invention comprises a first transmitter for configuring a radio receiver, which transmitter uses a third transmitting means to transmit at least one parameter to the radio receiver via a first connection of a first network, the radio receiver generating at least one configuration parameter after receiving the parameter by evaluating the at least one parameter and establishing a second connection to a second network on the basis of the at least one configuration parameter. In addition, the first transmitter with a control means may generate at least one of the parameters on the basis of a position or a current configuration parameter. The method can thus be implemented in the first network.

### BRIEF DESCRIPTION OF THE DRAWINGS

The invention and its developments are explained in more detail below using drawings, in which:

FIG. 1 shows a first exemplary embodiment having a radio receiver, a first network and a second network.

FIG. 2 shows an extension of the radio receiver for evaluating location-dependent information.

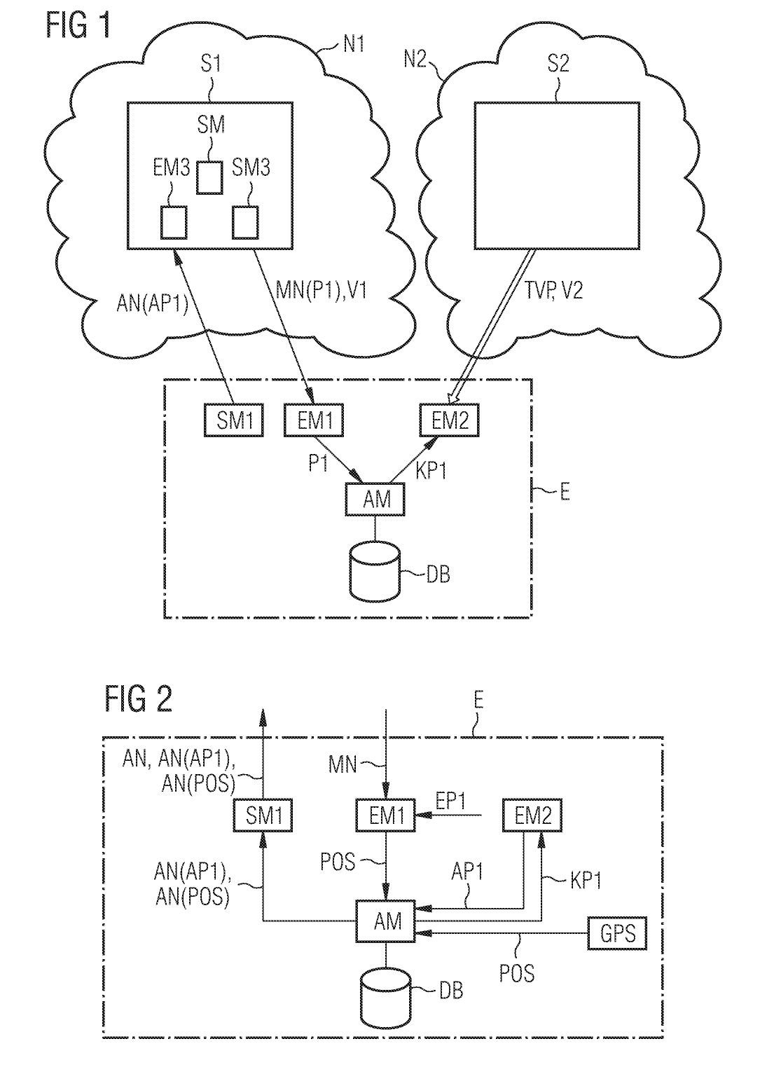

Elements having the same function and method of operation are provided with the same reference symbols in FIGS. 1 and 2.

### DETAILED DESCRIPTION OF THE INVENTION

One exemplary embodiment is explained in more detail with reference to FIG. 1. In this case, a radio receiver E, which is implemented in a mobile radio telephone according to the GSM standard (GSM—Global System for Mobile Communications), is intended to receive a television program by means of a DVB-H standard (DVB-H—Digital Video Broadcast Handheld). However, the radio receiver E does not have a configuration parameter KP1, such as a reception frequency, for receiving the television program.

In a first step, the radio receiver activates its first receiving device EM1 which receives at least one message MN via a first connection Vi of a first network N1. The first network operates according to the GSM standard. The received message MN comprises at least one parameter P1 which is forwarded to an evaluation means AM.

The evaluation means AM evaluates the parameter P1 and uses it to generate at least one configuration parameter KP1. In the exemplary embodiment, the parameter P1 specifies the reception frequency F which is adopted as the configuration parameter KP1, i.e. KP1=P1=F.

The evaluation means AM forwards at least one configuration parameter KP1 to a second receiving device EM2 which is configured using the configuration parameter. The second receiving means operates in the second network N2. The second receiving device EM2 is then able to receive the desired television program TVP from a second transmitter S2 via a second connection, i.e. DVB-H, and to output a television signal to a user (not illustrated graphically).

A plurality of extensions which can be combined in any desired combination with the first exemplary embodiment are explained below.

In a first development, at least the parameter P1 is evaluated on the basis of a database DB in the radio receiver and at least the one configuration parameter KP1 is generated from the evaluation. By way of example, the database comprises the following entries:

| P1 | KP1 = reception frequency | KP2 = ID of an IP platform |
|---|---|---|
| 0 | 490 MHz | 1 |
| 1 | 618 MHz | 17 |
| 2 | 642 MHz | 28 |

This table of the database reproduces an assignment of the parameter P1 to two configuration parameters. In this exemplary embodiment, the second network represents a DVB-H network. If the parameter P1=1, KP1=618 MHz and KP2=17.

In a second extension, a first transmitting device SM1 transmits a request message AN to a first transmitter S1 inside the first network N1. The first transmitter S1 receives the request message using a third receiving device EM3 and forwards the message to a control device SM for processing. The control means SM prompts a third transmitting device SM3 to transmit the message MN comprising the parameter(s) to the radio receiver E.

In a third development, a current configuration parameter AP1 is added to the request message according to FIG. 2. This current configuration parameter AP1 indicates a status of the second network. A currently received television program is thus intended to be played back to the user even after the handover of the second network. For this purpose, the evaluation device AM checks an IPDC service ID (IPDC—IP Datacast) of the DVB-H standard, which represents an identifier of the received television program. Therefore, AP1=“IPDC service ID”. This current configuration parameter API is then transmitted to the first transmitter, the control device SM creating the parameter on the basis of the current configuration parameter and transmitting it to the radio receiver.

In a fourth development, a request message AN is created and sent to the first network if a reception quality of the second network undershoots the predefinable reception quality. The user of the radio receiver, which has, for example, the first network according to the GSM standard, moves to an edge of a cell formed by the second network. Since the distance between the second transmitter S2 and the radio receiver E increases, the reception quality decreases. If the predefinable reception quality is undershot, in which case a signal-to-noise ratio is measured, for example, a new request message AN is sent since the reception quality can be improved by means of a possible handover to a new cell of the second network. On the basis of the request signal, a new message MN including a new parameter P1 is transmitted to the receiving device E which, after evaluating the new parameter P1 and creating a new configuration parameter KP1, reconfigures the second receiving device EM2 in order to receive the television program in the new cell.

In a fifth development, the first transmitter S1 of the first network N1 sends at least the one parameter P1 to the radio receiver E without a request. This can be carried out in predefinable intervals of time, for example every 60 seconds, after the radio receiver has been registered for the first time in a cell of the first network and/or after the radio receiver has been switched on.

In a sixth development, an indication of the position POS of the radio receiver E is determined by a positioning device GPS which operates, for example, according to a GPS standard (GPS—Global Positioning System). The positioning device is integrated in the radio receiver and provides the evaluation means AM with the indication of position. The evaluation means evaluates the indication of position and determines the configuration parameter KP1 taking into account the indication of position and the parameter. In this case, use may be made of a database which comprises, for example, the following entries:

| P1 | POS | KP1 = reception frequency | KP2 = ID of an IP platform |
|---|---|---|---|
| 0 | POS1 | 490 MHz | 1 |
| 0 | POS2 | 618 MHz | 17 |
| 1 | POS1 | 642 MHz | 28 |
| . . . | | | |

In this case, POS1, POS2 represent two different positions, for example a respective pair of degrees in the vertical and horizontal directions. In this case, that position POS1 which comes closest to the indication of position POS can be selected. The specific values for the configuration parameters, which can be taken from the database, depend on the parameter and the indication of position. If P1=1 and POS=POS1, KP1=642 MHz and KP2=28.

In an alternative embodiment to the sixth development, the indication of the position POS of the radio receiver is determined on the basis of the first network N1 rather than using the positioning device GPS. In this case, the indication of position can be determined by measuring the propagation times of a plurality of first transmitters which can represent base stations in the GSM network. A person skilled in the art is familiar with such methods for determining position and so they are not discussed in any more detail.

In a seventh development, the indication of position is determined according to the sixth development. This indication of position POS is transmitted, with the aid of a further request message AN, to the first network which, on the basis of the received indication of position POS, that is to say on the basis of a location of the radio receiver, transmits an associated parameter P1 to the radio receiver using the message MN.

In an eighth development, at least one of the configuration parameters is formed on the basis of at least one reception parameter EP1 which reflects a current status of the first network. The radio receiver is situated in a first cell of the first network, with the result that the reception parameter EP1 corresponds to an ID of the first cell. In a similar manner to the sixth extension, an entry is selected from the database, which specifies the at least one configuration parameter, on the basis of the current status.

The radio receiver, the first transmitter and/or the second transmitter are implemented using hardware and/or software and/or a combination of software and hardware, the software being executed on a processor having at least memories and input and output means.

1. A method for configuring a radio receiver, comprising:
receiving at least one parameter by a first receiving device of the radio receiver via a first connection of a first network;
generating at least one configuration parameter by evaluating the parameter; and
establishing a second connection to a second network by a second receiving device of the radio receiver based on the configuration parameter.

2. The method as claimed in claim 1, wherein
the parameters is requested by the radio receiver using a request message.

3. The method as claimed in claim 2, wherein
at least one current configuration parameter of the radio receiver is added to the request message.

4. The method as claimed in claim 2, wherein
the first network is provided with the request message when a reception quality of the second network is undershot.

5. The method as claimed in claim 1, wherein
the parameter is delivered to the radio receiver without a request from the radio receiver.

6. The method as claimed in, claim 1, wherein
the configuration parameter is generated by evaluating the parameters based on a database in the radio receiver.

7. The method as claimed in, claim 1, further comprising:
determining an indication of the position of the radio receiver using either at least one reception parameter of the first network or a positioning device, and
generating at least one of the configuration parameters by evaluating either the indication of position based on the database or by evaluating the parameter which is requisitioned using a request message which comprises the indication of position.

8. The method as claimed in claim 1, wherein
the first networks is used to represent a unidirectional or bidirectional network, the bidirectional network comprising one of a UMTS, GSM, WLAN or WIMAX standard.

9. The method as claimed in claim 1, wherein
the second network is used to represent a radio network, where the radio network comprises one of a DVB-H, DVB-T, DAB or DMB standard.

10. The method as claimed in claim 9, wherein
when using the second network according to DVB-T, at least one of the configuration parameters and/or parameters comprises at least one of the following items of information:
reception frequency,
DVB network ID.
DVB original network ID,
DVB transport stream ID,
DVB service ID.

11. The method as claimed in claim 9, wherein
when using the second network according to DVB-H, at least one of the configuration parameters and/or parameters comprises at least one of the following items of information:
reception frequency.
DVB network ID (optional).
DVB original network ID.
DVB transport stream ID.
IP platform ID,
ID of the IPDC electronic service guide provider,
IPDC service ID.

12. The method as claimed in claim 1, wherein
the parameter is generated based on a position of the radio receiver inside the first network.

13. A radio receivers, comprising:
a first receiving device for receiving at least one parameter via a first connection of a first network;
an evaluation device for generating at least one configuration parameter by evaluating the at least one parameters;
a second receiving device for establishing a second connection to a second network based on the at least one configuration parameter.

14. The radio receivers as claimed in claim 13, wherein,
the radio receiver performs the following:
receiving at least one parameter by a first receiving device of the radio receiver via a first connection of a first network;
generating at least one configuration parameter by evaluating the parameter; and
establishing a second connection to a second network by a second receiving device of the radio receiver based on the configuration parameter.

15. A first transmitter for configuring a radio receiver, comprising:
a third transmitting device for transmitting at least one parameters to a first receiving device of the radio receiver via a first connections of a first network, the radio receiver generating at least one configuration parameter after receiving the parameter by evaluating the at least one parameters, and a second connection to a second network being established by a second receiving device of the radio receiver based on the at least one configuration parameter.

16. The first transmitters as claimed in claim 15, wherein the first transmitter with a control device generates at least one of the parameters based on position of the radio receiver or based on a current configuration parameter of the radio receiver.
